(19) United States
(12) Patent Application Publication
(10) Pub. No.: US 2025/0317073 A1
(43) Pub. Date: Oct. 9, 2025

(54) INTEGRATED CIRCUIT AND POWER SUPPLY CIRCUIT

(71) Applicant: FUJI ELECTRIC CO., LTD., Kawasaki-shi (JP)

(72) Inventor: Yukihiro YAGUCHI, Matsumoto-city (JP)

(73) Assignee: FUJI ELECTRIC CO., LTD., Kawasaki-shi (JP)

(21) Appl. No.: 19/062,989

(22) Filed: Feb. 25, 2025

(30) Foreign Application Priority Data
Apr. 4, 2024 (JP) 2024-060819

(51) Int. Cl. H02M 7/537; H02M 1/00; H02M 1/08

(52) U.S. Cl. CPC H02M 7/537; H02M 1/0016; H02M 1/08

(57) ABSTRACT

A switching control circuit for a power supply circuit including an inductor and a transistor. The switching control circuit switches the transistor, and includes: a driver circuit configured to turn on the transistor when an inductor current becomes smaller than a predetermined value, and turn off the transistor when a time period corresponding to an output voltage elapses; a detection circuit configured to detect whether on-period of the transistor is shorter than a first time period; and a first time measurement circuit configured to measure a second time period upon detecting that the on-period is shorter than the first time period. Upon detecting that the on-period is shorter than the first time period, the driver circuit turns on the transistor based on completion of measurement of the second time period, irrespective of the inductor current. The second time period is shorter than a period corresponding to a highest audible frequency.

### CROSS-REFERENCE TO RELATED APPLICATION

This application claims priority pursuant to 35 U.S.C. § 119 from Japanese Patent Application No. 2024-060819, filed on Apr. 4, 2024, of which is incorporated herein by reference.

### BACKGROUND

### Technical Field

The present invention relates to an integrated circuit and a power supply circuit.

### Related Art

A power supply circuit that generates an output voltage of a target level from an AC voltage typically includes a transistor which is switched according to the output voltage and a coil (see, for example, Japanese Patent Application Publication Nos. 2006-262548, 2013-188082, and 2012-105424).

Incidentally, when a load coupled to the power supply circuit is in a low load state, switching of the transistor may be halted to prevent the output voltage from exceeding the target level. When the output voltage decreases after the halt of the switching of the transistor, the switching of the transistor is resumed. In such a case, if a frequency according to the transistor's switching period falls within the audible frequency range, audible ringing is produced from the coil.

### SUMMARY

In order to solve the above-mentioned problem, an aspect of a switching control circuit of the present invention is a switching control circuit for a power supply circuit that generates an output voltage at a target level from an alternating current (AC) voltage, the power supply circuit including an inductor configured to receive a rectified voltage from a full-wave rectifier circuit configured to rectify the AC voltage, a transistor configured to control an inductor current flowing through the inductor, the switching control circuit configured to switch the transistor, the switching control circuit comprising: a driver circuit configured to turn on the transistor when the inductor current becomes smaller than a predetermined value, and turn off the transistor when a time period corresponding to the output voltage elapses; a detection circuit configured to detect whether an on-period of the transistor is shorter than a first time period; and a first time measurement circuit configured to measure a second time period upon detecting that the on-period is shorter than the first time period, wherein upon detecting that the on-period is shorter than the first time period, the driver circuit turns on the transistor based on completion of measurement of the second time period, irrespective of the inductor current, and the second time period is shorter than a period corresponding to a highest audible frequency.

Furthermore, an aspect of a power supply circuit is configured to generate an output voltage at a target level from an alternating current (AC) voltage, the power supply circuit comprising: an inductor configured to receive a rectified voltage from a full-wave rectifier circuit configured to rectify the AC voltage; a transistor configured to control an inductor current flowing through the inductor; and a switching control circuit configured to switch the transistor, the switching control circuit including a driver circuit configured to turn on the transistor when the inductor current becomes smaller than a predetermined value and turn off the transistor when a time period corresponding to the output voltage elapses; a detection circuit configured to detect whether an on-period of the transistor is shorter than a first time period, and a first time measurement circuit configured to measure a second time period upon detecting that the on-period is shorter than the first time period, wherein upon detecting that the on-period is shorter than the first time period, the driver circuit turns on the transistor based on completion of measurement of the second time period, irrespective of the inductor current, and the second time period is shorter than a period corresponding to a highest audible frequency.

The summary of the present invention described above does not list all the features necessary for the present invention. Further, sub-combinations of these features may also be inventions.

### BRIEF DESCRIPTION OF THE DRAWINGS

FIG. 1 is a diagram showing an example configuration of an AC-DC converter 10.

FIG. 2 is a diagram showing an example configuration of a power factor correction IC 29a.

FIG. 3 is a diagram showing an example operation by the power factor correction IC 29a.

FIG. 4 is a diagram showing an example operation by the power factor correction IC 29a.

FIG. 5 is a diagram showing an example operation by the power factor correction IC 29a.

FIG. 6 is a diagram showing an example operation by a power factor correction IC 29b.

FIG. 7 is a diagram showing an example operation by the power factor correction IC 29b.

### DETAILED DESCRIPTION

The present invention will be described below through an embodiment of the invention, but the following embodiment is not provided to limit the invention according to the scope of claims. Further, not all combinations of the features described in the embodiment are essential s solutions provided by the invention. The same or like constituents, members, and the like shown in the drawings are denoted by the same reference numerals, and repeated descriptions are omitted as needed.

The term “couple” used herein means “electrically couple” unless otherwise noted. A voltage or a signal is herein referred to as having a high level (referred to as high or high level) when its logical level is high and referred to as having a low level (low or low level) when its logical level is low.

### EMBODIMENTS

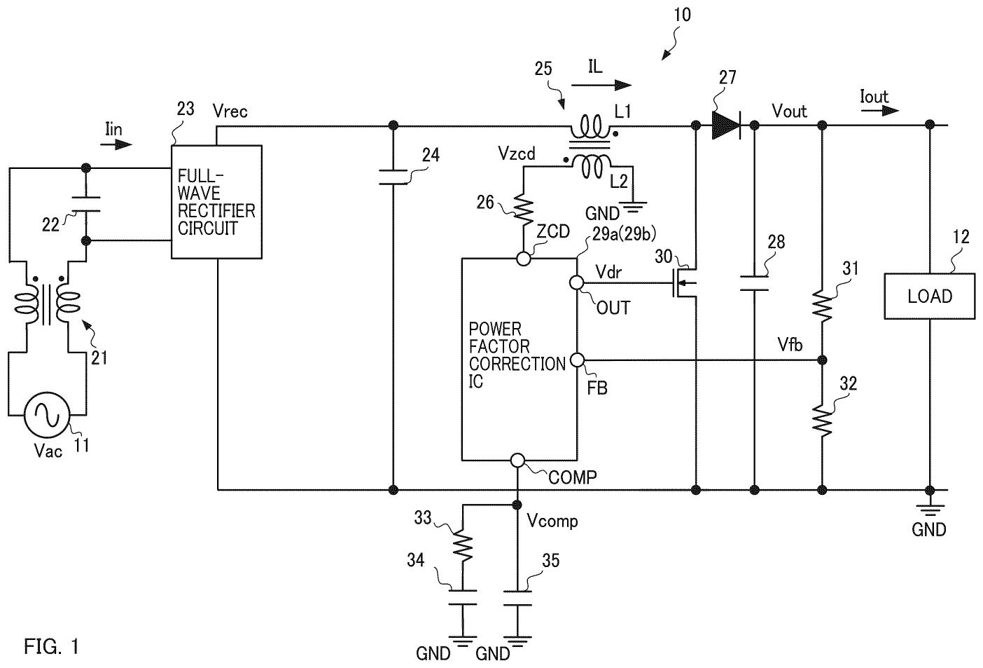

FIG. 1 is a diagram showing an example configuration of an AC-DC converter 10. The AC-DC converter 10 is a boost-chopper-type power supply circuit that generates an output voltage Vout of a target level from an AC voltage Vac of an AC power supply 11. The AC-DC converter 10 supplies an output current Iout to a load 12 and applies the output voltage Vout to the load 12.

The AC power supply 11 is a commercial AC power supply for applying the AC voltage Vac to the AC-DC converter 10. The AC voltage Vac is a voltage of, for example, 100 V to 277 V with a frequency of 50 Hz to 60 Hz. The load 12 is, for example, a DC-to DC convertor or an electronic device that operates at DC voltage.

### <<Configuration of the AC-DC Converter 10>>

The AC-DC converter 10 includes a choke coil 21, capacitors 22, 24, 28, 34, and 35, a full-wave rectifier circuit 23, a transformer 25, resistors 26 and 31 to 33, a diode 27, a power factor correction IC 29a, and a MOS transistor 30.

### ==Input to the Full-Wave Rectifier Circuit 23==

The choke coil 21 and the capacitor 22 remove noise from a current and the voltage Vac supplied from the AC power supply 11 to the full-wave rectifier circuit 23. A voltage which is the voltage Vac removed of noise and an input current Iin are supplied from the AC power supply 11 to the full-wave rectifier circuit 23 via the choke coil 21 and the capacitor 22.

### ==Configurations of the Full-Wave Rectifier Circuit 23 to the Load 12==

The full-wave rectifier circuit 23 performs full-wave rectification on the predetermined AC voltage Vac and applies the result to the capacitor 24 and a primary coil L1 of the transformer 25 as a rectified voltage Vrec. The full-wave rectifier circuit 23 is a typical diode bridge circuit with four diodes.

The capacitor 24 smooths the rectified voltage Vrec applied from the full-wave rectifier circuit 23 and removes noise.

The transformer 25 includes the primary coil L1 and an auxiliary coil L2 that is magnetically coupled to the primary coil L1. The auxiliary coil L2 of the present embodiment is wound so that the polarity of the voltage generated at the auxiliary coil L2 may be the opposite from the polarity of the voltage generated at the primary coil L1.

The auxiliary coil L2 is coupled to a terminal ZCD of the power factor correction IC 29a (described later) via the resistor 26. Since a current in accordance with an inductor current IL flowing through the primary coil L1 flows through the auxiliary coil L2, a voltage Vzcd in accordance with the inductor current IL is applied to the terminal ZCD.

The primary coil L1 of the transformer 25 configures a boost chopper circuit together with the MOS transistor 30 (described later), the diode 27, and the capacitor 28. Thus, a charging voltage from the capacitor 28 is boosted to the DC output voltage Vout and supplied to the load 12.

The power factor correction IC 29a is an integrated circuit that improves the power factor of the AC-DC converter 10 and also controls the switching of the MOS transistor 30 so that the output voltage Vout reaches a target level (e.g., 400 V). The power factor correction IC 29a drives the MOS transistor 30 based on the output voltage Vout and the inductor current IL flowing through the primary coil L1.

The power factor correction IC 29a includes terminals COMP, FB, OUT, and ZCD. The power factor correction IC 29a also has other terminals in addition to the terminals COMP, FB, OUT, and ZCD (such as, for example, a power supply terminal and a GND terminal), but such other terminals are omitted in the drawings. The power factor correction IC 29a corresponds to the “switching control circuit.”

The MOS transistor 30 is a power transistor for controlling power from the AC-DC converter 10 to the load 12. Specifically, the MOS transistor 30 controls the inductor current IL flowing through the primary coil L1 of the transformer 25.

The MOS transistor 30 of the present embodiment is an N-type metal oxide semiconductor (MOS) transistor, but the present invention is not limited to this. Specifically, the MOS transistor 30 only needs to be a transistor capable of controlling power and may be, for example, a bipolar transistor. The gate electrode of the MOS transistor 30 is coupled to the terminal OUT of the power factor correction IC 29a.

A voltage Vdr is applied from the power factor correction IC 29a to the gate electrode of the MOS transistor 30. The power factor correction IC 29a controls power to the load 12 by controlling the timing to change the voltage level of the voltage Vdr.

The resistors 31 and 32 configure a voltage divider circuit and, in accordance with the output voltage Vout, generate a feedback voltage Vfb used in switching of the MOS transistor 30. The voltage divider circuit obtains the voltage Vfb by voltage division and applies it as a feedback voltage to the terminal FB of the power factor correction IC 29a.

The resistor 33 and the capacitors 34 and 35 are phase compensation elements used for feedback control. The resistor 33 and the capacitor 34 are provided in series between the terminal COMP and the ground. The capacitor 35 is provided in parallel with the resistor 33 and the capacitor 34.

Further, as described in detail later, the power factor correction IC 29a turns on the MOS transistor 30 when the inductor current IL flowing through the primary coil L1 of the transformer 25 becomes a predetermined value (e.g., almost zero (“almost zero” is hereinafter referred to as “zero”). Then, the power factor correction IC 29a turns off the MOS transistor 30 based on a voltage Vcomp at the terminal COMP.

==Configuration of the Power Factor Correction IC 29a==

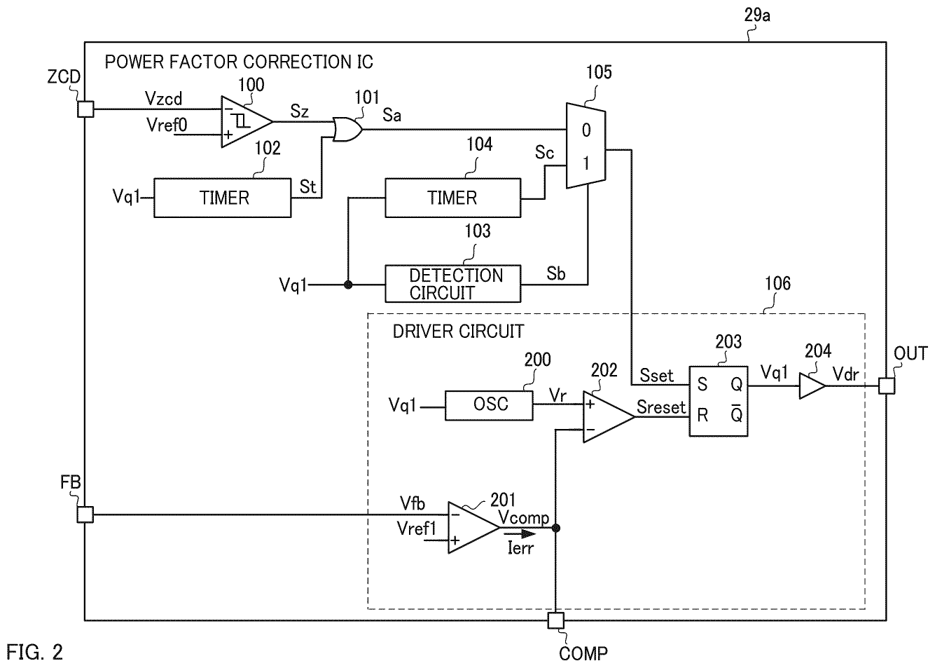

FIG. 2 shows an example configuration of the power factor correction IC 29a. The power factor correction IC 29a is configured including a hysteresis comparator 100, an OR circuit 101, timers 102 and 104, a detection circuit 103, a selector 105, and a driver circuit 106.

The hysteresis comparator 100 is a circuit that detects, based on the voltage Vzcd applied to the terminal ZCD, whether the inductor current IL reaches zero. Since the auxiliary coil L2 is electromagnetically coupled to the primary coil L1, the voltage Vzcd applied to the terminal ZCD is a voltage in accordance with the inductor current IL flowing through the primary coil.

Specifically, the hysteresis comparator 100 detects whether the inductor current IL reaches zero by comparing the voltage Vzcd with thresholds Vthl and Vthh which are in accordance with a reference voltage Vref0.

When the inductor current IL decreases to zero, the voltage Vzcd falls below the threshold Vthl. Then, the hysteresis comparator 100 outputs a high signal Sz to the OR circuit 101. In contrast, when the inductor current IL increases and the voltage Vzcd exceeds the threshold Vthh, the hysteresis comparator 100 outputs a low signal Sz to the OR circuit 101.

The threshold Vthl is in accordance with the reference voltage Vref0 applied to the hysteresis comparator 100 and is the lower one of the thresholds used by the hysteresis comparator 100. Similarly, the threshold Vthh is in accordance with the reference voltage Vref0 and is the higher one of the thresholds used by the hysteresis comparator 100.

Since the hysteresis comparator 100 thus compares the voltage Vzcd with two thresholds, namely the thresholds Vthl and Vthh, the hysteresis comparator 100 does not erroneously fluctuate its output even if the voltage Vzcd fluctuates slightly due to noise. Thus, the hysteresis comparator 100 can reduce the influence of noise on the voltage Vzcd.

The OR circuit 101 is a circuit that performs a logical OR operation between the signal Sz and a pulse signal St from the timer 102 (described later). Thus, the OR circuit 101 outputs a high signal Sa to the selector 105 (described later) upon receiving input of the pulse signal St from the timer 102 or the signal Sz.

The timer 102 is a circuit that outputs the pulse signal St for turning on the MOS transistor 30, when the hysteresis comparator 100 cannot detect that the inductor current IL becomes zero after the MOS transistor 30 is turned off. Specifically, if the inductor current IL does not become zero within a predetermined time period T1 (e.g., 10 microseconds) from when the MOS transistor 30 is turned off, the timer 102 outputs the pulse signal St to turn on the MOS transistor 30.

Meanwhile, upon receiving a high driving signal Vq1 because the MOS transistor 30 is turned on within the predetermined time period T1, the timer 102 resets time measurement of the predetermined time period T1. Then, upon receiving a low driving signal Vq1, the timer 102 resumes time measurement. Thus, the timer 102 stops outputting the pulse signal St if the MOS transistor 30 is turned on within the predetermined time period T1. The timer 102 corresponds to the “second time measurement circuit,” and the predetermined time period T1 corresponds to the “third time period.”

The detection circuit 103 is a circuit that detects whether an on-period Ton of the MOS transistor 30 is shorter than a predetermined on-period Ton0. Specifically, the detection circuit 103 outputs a high signal Sb when the on-period Ton is shorter than the on-period Ton. Then, when the MOS transistor 30 is turned on after the output of the high signal Sb and the on-period Ton becomes longer than the on-period Ton0, the detection circuit 103 outputs a low signal Sb. The on-period Ton0 corresponds to the “first time period.”

==Timer 104==

The timer 104 is a circuit that measures a predetermined period T2 (described later). Upon receiving input of a high driving signal Vq1, the timer 104 resets time measurement of the predetermined period T2 and resumes time measurement. Then, if no high driving signal Vq1 is inputted thereto within the predetermined period T2, the timer 104 outputs a pulse signal Sc. The predetermined period T2 is longer than the predetermined time period T1 (e.g., 10 microseconds) and is shorter than a period corresponding to a frequency (preferably 25 kHz) higher than the highest frequency (e.g., 20 kHz) of the audible frequency range (e.g., 20 Hz to 20 kHz). The timer 104 corresponds to the “first time measurement circuit,” and the predetermined period T2 corresponds to the “second time period.”

Based on the detection result from the detection circuit 103, the selector 105 outputs either the signal from the OR circuit 101 or the signal Sc from the timer 104, as a signal Sset. Specifically, the selector 105 outputs the signal Sa as the signal Sset when the on-period Ton of the MOS transistor 30 is longer than the on-period Ton0 and the detection circuit 103 outputs a low signal Sb. Meanwhile, the selector 105 outputs the pulse signal Sc as the signal Sset when the on-period Ton of the MOS transistor 30 is shorter than the on-period Ton0 and the detection circuit 103 outputs a high signal Sb.

### ==Driver Circuit 106==

The driver circuit 106 is a circuit that performs switching of the MOS transistor 30 based on the pulse signal Sset from the selector 105 and the feedback voltage Vfb. Specifically, the driver circuit 106 turns on the MOS transistor 30 upon receiving input of the pulse signal Sset, and turns off the MOS transistor 30 in response to a time period corresponding to the feedback voltage Vfb having elapsed. The driver circuit 106 is configured including an oscillator (OSC) 200, an error amplification circuit 201, a comparator 202, an SR flip-flop 203, and a buffer 204.

The oscillator 200 is a circuit that outputs an oscillation voltage Vramp, when the MOS transistor 30 is turned on and the voltage level of the oscillation voltage Vramp changes at a predetermined slope. Specifically, when the MOS transistor 30 is on (i.e., when the driving signal Vq1 is high), the oscillator 200 outputs the oscillation voltage Vramp from a predetermined level V0. Meanwhile, when the MOS transistor 30 is off (i.e., when the signal Vq1 is low), the oscillator 200 sets the voltage level of the oscillation voltage Vramp to the predetermined level V0. The predetermined level V0 is higher than the voltage level of the ground voltage.

The error amplification circuit 201 is a transconductance amplifier and is a circuit that discharges the capacitors 34 and 35 in FIG. 1 via the terminal COMP so as to shorten the on-period of the MOS transistor 30 when the output voltage Vout exceeds the target level.

Specifically, when the feedback voltage Vfb in accordance with the output voltage Vout is lower than a reference voltage Vref1, the error amplification circuit 201 charges the capacitors 34 and 35 with a current Ierr. Meanwhile, when the feedback voltage Vfb is higher than the reference voltage Vref1, the error amplification circuit 201 discharges the capacitors 34 and 35 with the current Ierr. The voltage at the terminal COMP is the voltage Vcomp.

The comparator 202 is a circuit that compares the oscillation voltage Vramp outputted from the oscillator 200 and the voltage Vcomp and outputs a signal Sreset when the voltage level of the oscillation voltage Vramp reaches the voltage level of the voltage Vcomp in accordance with the feedback voltage Vfb. Specifically, the comparator 202 outputs a low signal Sreset to the SR flip-flop 203 when the voltage level of the oscillation voltage Vramp is lower than the voltage level of the voltage Vcomp.

Meanwhile, the comparator 202 outputs a high signal Sreset to the SR flip-flop 203 to turn off the MOS transistor 30 when the voltage level of the oscillation voltage Vramp is higher than the voltage level of the voltage Vcomp.

The SR flip-flop 203 is a circuit that changes the Q-output based on the pulse signal Sset and the signal Sreset and outputs the result as the driving signal Vq1. Specifically, when the selector 105 outputs the pulse signal Sset, the SR flip-flop 203 outputs a high driving signal Vq1.

Meanwhile, when the comparator 202 outputs a high signal Sreset, the SR flip-flop 203 outputs a low driving signal Vq1. The SR flip-flop 203 is a reset-prioritizing flip-flop.

Thus, when the voltage Vcomp falls below the voltage V0, the comparator 202 always outputs a high signal Sreset, and as a result, the SR flip-flop 203 always outputs a low driving signal Vq1.

On the other hand, when the voltage Vcomp exceeds the voltage V0 since the output voltage Vout is low and the voltage level of the oscillation voltage Vramp is lower than the voltage level of the voltage Vcomp, the comparator 202 outputs a low signal Sreset. Further, while the hysteresis comparator 100 is outputting a high signal Sz, the SR flip-flop 203 outputs a high driving signal Vq1. As a result, the MOS transistor 30 is turned on.

However, how the output voltage Vout lowers changes depending on the system of the AC-DC converter 10. Thus, without the detection circuit 103, the timer 104, and the selector 105, a period from when the MOS transistor 30 is turned on to when the MOS transistor 30 is turned on again may be a period corresponding to the frequencies of the audible frequency range. Further, when the MOS transistor 30 is thus switched intermittently, the primary coil L1 may produce audible ringing.

The buffer 204 is a circuit that applies the voltage Vdr that turns on the MOS transistor 30 to the MOS transistor 30 upon receiving input of a high driving signal Vq1 and applies the voltage Vdr that turns off the MOS transistor 30 to the MOS transistor 30 upon receiving input of a low driving signal Vq1.

### <<<Operation Performed by the Power Factor Correction IC 29a During Normal Operation>>>

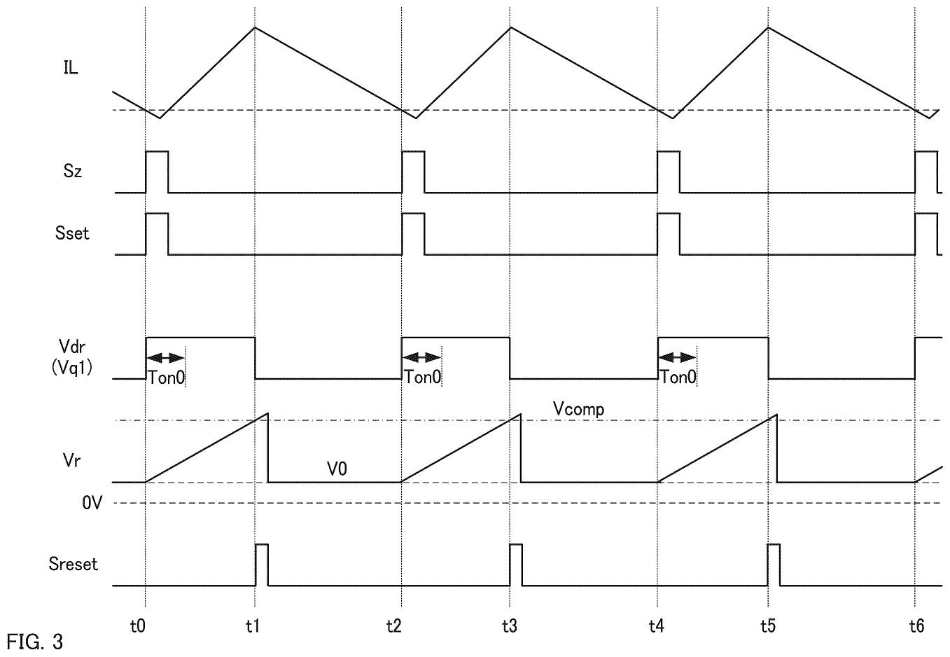

FIG. 3 is a diagram showing an example operation by the power factor correction IC 29a. In FIG. 3, the detection circuit 103 is outputting a low signal Sb since the on-period Ton is longer than the on-period Ton0.

At time point to, after the hysteresis comparator 100 outputs a high signal Sz since the inductor current IL becomes almost zero, the OR circuit 101 outputs a high signal Sa, and the selector 105 outputs the signal Sset. When the signal Sset is outputted, the SR flip-flop 203 outputs a high driving signal Vq1, and the buffer 204 outputs the voltage Vdr that turns on the MOS transistor 30. When the MOS transistor 30 is turned on, the inductor current IL increases. Then, the oscillator 200 starts outputting the oscillation voltage Vramp the voltage level of which changes from the predetermined level V0 at a predetermined slope.

At time point t1 which the voltage level of the oscillation voltage Vramp matches the voltage level of the voltage Vcomp, the comparator 202 outputs a high signal Sreset. Then, the SR flip-flop 203 outputs a low driving signal Vq1, and the buffer 204 outputs the voltage Vdr that turns off the MOS transistor 30. When the MOS transistor 30 is turned off, the inductor current IL starts decreasing. Further, the oscillator 200 sets the voltage level of the oscillation voltage Vramp to the predetermined level V0. After time point t2, the same operation is repeated.

### <<<Operation Performed by the Power Factor Correction IC 29a During Abnormal Operation>>>

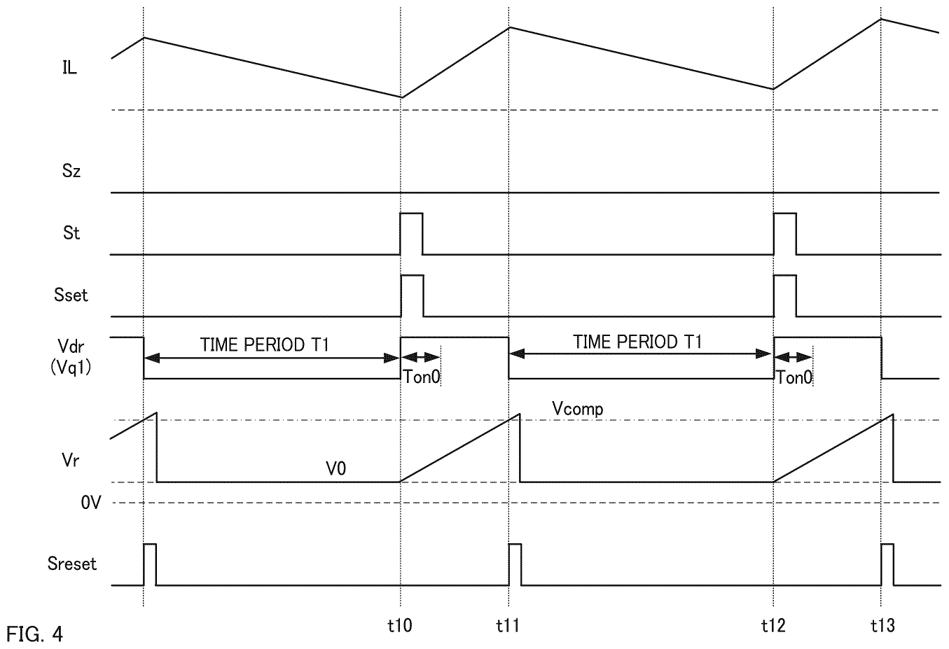

FIG. 4 is a diagram showing an example operation performed by the power factor correction IC 29a during abnormal operation (a situation different from normal situation, such as starting up power supply). In FIG. 4, the detection circuit 103 is outputting a low signal Sb because the on-period Ton is longer than the on-period Ton0.

At time point t10 which the time period T1 elapses from when the MOS transistor 30 is turned off, the timer 102 completes time measurement of the time period T1 and outputs the pulse signal St. When the timer 102 outputs the pulse signal St, the OR circuit 101 outputs a high signal Sa, and the selector 105 outputs the signal Sset. Then, the MOS transistor 30 is turned on.

Such a situation, in which the inductor current IL does not become zero even after a lapse of the period T1 from when the MOS transistor 30 is turned off, may occur upon activation. In this case, the MOS transistor 30 is turned on based on the pulse signal St outputted from the timer 102. Further, the timer 102 may also output the pulse signal St, when the decreasing slope of the inductor current IL becomes small since a temperature increase of the primary coil L1 results in an increase of the inductance value of the primary coil L1 due to temperature characteristics.

When the MOS transistor 30 is turned on, the inductor current IL increases. Then, the oscillator 200 starts outputting the oscillation voltage Vramp the voltage level of which changes from the predetermined level V0 at a predetermined slope.

At time point t11 which the voltage level of the oscillation voltage Vramp matches the voltage level of the voltage Vcomp, the comparator 202 outputs a high signal Sreset. Then, the MOS transistor 30 is turned off. When the MOS transistor 30 is turned off, the inductor current IL starts decreasing. Further, the oscillator 200 sets the voltage level of the oscillation voltage Vramp to the voltage V0. After that, the same operation is repeated.

In this way, the timer 102 outputs the signal St when the predetermined time period T1 elapses from when the MOS transistor 30 is turned off with the hysteresis comparator 100 unable to detect that the inductor current IL becomes zero. Thus, the power factor correction IC 29a can cause the AC-DC converter 10 to keep operating continuously without lowering the output voltage Vout, even if unexpectedly the hysteresis comparator cannot detect that the inductor current IL becomes zero within the predetermined time period T1.

<<<Operation Performed by the Power Factor Correction IC 29a when the On-Period Ton is Shorter than the On-Period Ton0>>>

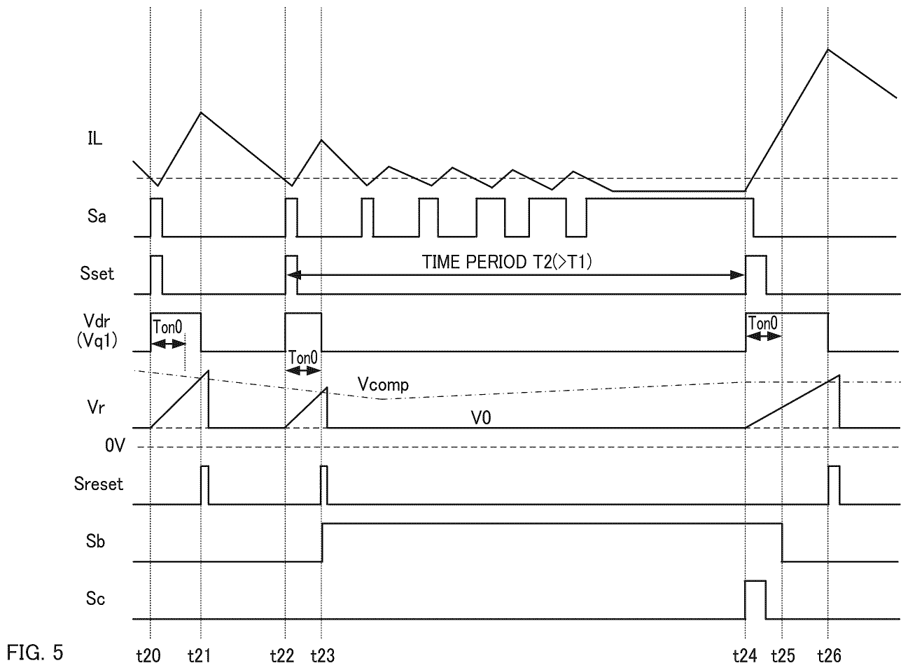

FIG. 5 is a diagram showing an example operation by the power factor correction IC 29a.

At time point t20, when the inductor current IL becomes almost zero and the hysteresis comparator 100 outputs a high signal Sz, the OR circuit 101 outputs a high signal Sa, and the selector 105 outputs the signal Sset. When the signal Sset is outputted, the e SR flip-flop 203 outputs a high driving signal Vq1, and the buffer 204 outputs the voltage Vdr that turns on the MOS transistor 30. When the MOS transistor 30 is turned on, the inductor current IL increases. Then, the oscillator 200 starts outputting the oscillation voltage Vramp the voltage level of which changes from the predetermined level V0 at a predetermined slope.

At time point t21 which the voltage value of the oscillation voltage Vramp matches the voltage level of the voltage Vcomp, the comparator 202 outputs a high signal Sreset. Then, the SR flip-flop 203 outputs a low driving signal Vq1, and the buffer 204 outputs the voltage Vdr that turns off the MOS transistor 30. When the MOS transistor 30 is turned off, the inductor current IL starts decreasing. Further, the oscillator 200 sets the voltage level of the oscillation voltage Vramp to the predetermined level V0.

At time point t22, the power factor correction IC 29a operates similarly to time point t20.

At time point t23, the voltage level of the oscillation voltage Vramp matches the voltage level of the voltage Vcomp, and the comparator 202 outputs a high signal Sreset. Then, the MOS transistor 30 is turned off. When the MOS transistor 30 is turned off, the inductor current IL starts decreasing. The oscillator 200 sets the voltage level of the oscillation voltage Vramp to the predetermined level V0. Further, at time point t23, when the MOS transistor 30 is turned off and the on-period Ton becomes shorter than the on-period Ton0, the detection circuit 103 outputs a high signal Sb.

Thus, after time point t23, the selector 105 does not output a high signal Sset even if the hysteresis comparator 100 outputs a high signal Sz and the OR circuit 101 outputs a high signal Sa due to ringing of the voltage Vzcd in accordance with the inductor current IL.

At time point t24 which the time period T2 elapses from time point t22, at which the MOS transistor 30 is turned on, the timer 104 outputs the pulse signal Sc. When the timer 104 outputs the pulse signal Sc, the selector 105 outputs a high signal Sset. Then, the MOS transistor 30 is turned on. While the time period T2 that elapses from time point t22, the output voltage Vout is likely to decrease and the voltage Vcomp is likely to increase. Therefore, after the MOS transistor 30 is turned on at time point t24, the on-period Ton of the MOS transistor 30 is likely to be longer than the on-period Ton0.

At time point t25 which the on-period Ton0 elapsed from when the MOS transistor 30 is turned on, the detection circuit 103 outputs a low signal Sb.

At time point t26, the voltage level of the oscillation voltage Vramp matches the voltage level of the voltage Vcomp, and the comparator 202 outputs a high signal Sreset. Then, the MOS transistor 30 is turned off. When the MOS transistor 30 is turned off, the inductor current IL starts decreasing. Further, the oscillator 200 sets the voltage level of the oscillation voltage Vramp to the predetermined level V0.

In this way, when the on-period Ton becomes shorter than the on-period Ton0, the detection circuit 103 outputs a high signal Sb, and the selector 105 outputs only the pulse signal Sc from the timer 104 as the signal Sset. Thus, for example, the time period from time point t22 to time point t24 is the time period T2 (e.g., preferably, a period corresponding to 25 kHz). As a result, irrespective of the system of the AC-DC converter 10, the lowest frequency of the switching frequencies of the MOS transistor 30 is higher than the highest frequency (20 kHz) of the audible frequency range. This restrains audible ringing of the primary coil L1.

### MODIFICATION EXAMPLES

==Configuration of the Power Factor Correction IC 29b===

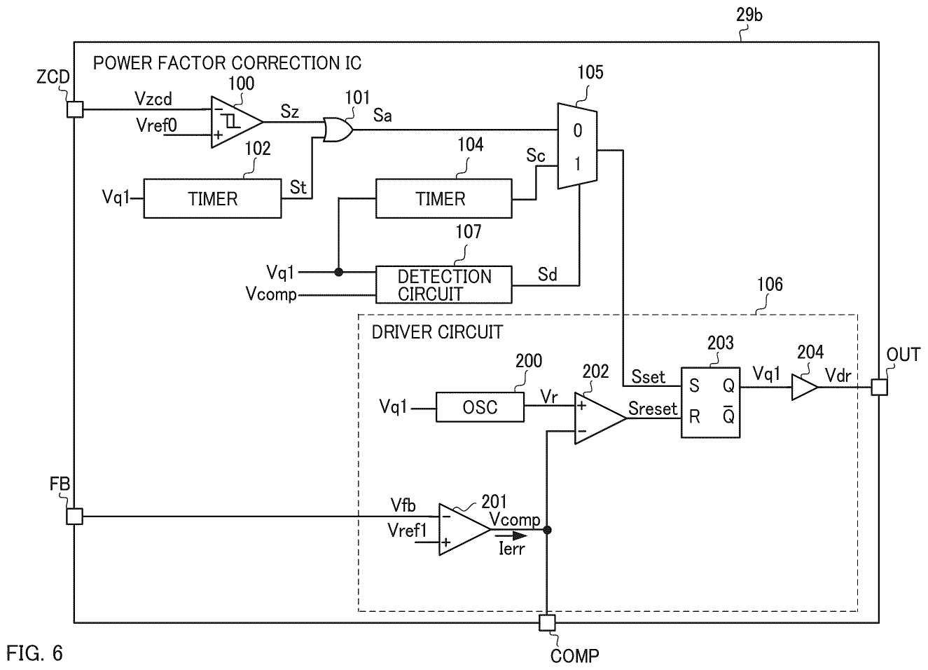

The power factor correction IC 29a is described above. FIG. 6 is a diagram showing an example configuration of a power factor correction IC 29b, which is a modification of the power factor correction IC 29a. The power factor correction IC 29b is configured including the hysteresis comparator 100, the OR circuit 101, the timers 102 and 104, a detection circuit 107, the selector 105, and the driver circuit 106.

The detection circuit 107 is a circuit that detects whether the voltage Vcomp is higher than a reference voltage Vref2. Specifically, the detection circuit 107 outputs a high signal Sd when the voltage Vcomp falls below the reference voltage Vref2. Then, after the output of the high signal Sd, the detection circuit 107 outputs a low signal Sd when the SR flip-flop 203 changes the level of the driving signal Vq1 from high to low.

<<<Operation Performed by the Power Factor Correction IC 29b when the Voltage Vcomp is Lower than the Reference Voltage Vref2>>>

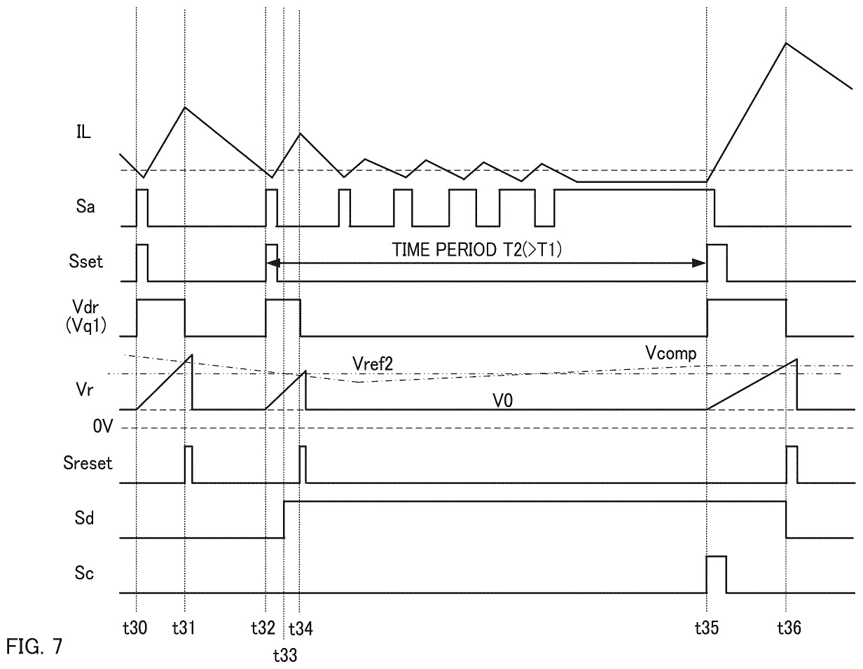

FIG. 7 is a diagram showing an example operation by the power factor correction IC 29b. The operation performed by the power factor correction IC 29b during the period from time point t30 to time point t32 is the same as the operation performed by the power factor correction IC 29a during the period from time point t20 to time point t22 in FIG. 5.

At time point t33 which the voltage Vcomp falls below the reference voltage Vref2, the detection circuit 107 outputs a high signal Sd. Thus, after time point t33, the selector 105 does not output a high signal Sset even if the hysteresis comparator 100 outputs a high signal Sz and the OR circuit 101 outputs a high signal Sa due to ringing of the voltage Vzcd in accordance with the inductor current IL.

At time point t34, the voltage level of the oscillation voltage Vramp matches the voltage level of the voltage Vcomp, and the comparator 202 outputs a high signal Sreset. Then, the MOS transistor 30 is turned off. When the MOS transistor 30 is turned off, the inductor current IL starts decreasing. Further, the oscillator 200 sets the voltage level of the oscillation voltage Vramp to the predetermined level V0.

The timer 104 outputs the pulse signal Sc at time point t35 which the time period T2 elapses from time point t32, at which the MOS transistor 30 is turned on. When the timer 104 outputs the pulse signal Sc, the selector 105 outputs a high signal Sset. Then, the MOS transistor 30 is turned on. While the time period T2 that elapses from time point t32, the output voltage Vout is likely to decrease and the voltage Vcomp is likely to become higher than the reference voltage Vref2.

At time point t36 which the voltage level of the oscillation voltage Vramp matches the voltage level of the voltage Vcomp, the comparator 202 outputs a high signal Sreset. Then, the MOS transistor 30 is turned off. Also, the detection circuit 103 outputs a low signal Sd. When the MOS transistor 30 is turned off, the inductor current IL starts decreasing. Further, the oscillator 200 sets the voltage level of the oscillation voltage Vramp to the predetermined level V0.

In this way, when the voltage Vcomp falls below the reference voltage Vref2, the detection circuit 107 outputs a high signal Sd, and the selector 105 outputs only the pulse signal Sc from the timer 104 as the signal Sset. Thus, the time period from, for example, time point t32 to time period t35 is the time period T2 (e.g., preferably, a period corresponding to 25 kHz). As a result, as is similar to the case of using the power factor correction IC 29a, irrespective of the system of the AC-DC converter 10, the lowest frequency of the switching frequencies of the MOS transistor 30 is higher than the highest frequency (20 kHz) of the audible frequency range. Thus, similar to a case of using the power factor correction IC 29a, using the power factor correction IC 29b also constrains audible ringing of the primary coil L1.

### OVERVIEW

The AC-DC converter 10 of the present embodiment is described above. The power factor correction IC 29a has the driver circuit 106, the detection circuit 103, and the timer 104. Further, when the timer 104 measures the time period T2 which is shorter than a period corresponding to the highest frequency of the audible frequency range, the driver circuit 106 turns on the MOS transistor 30. Thus, an integrated circuit that reduces audible ringing of the coil can be provided.

The power factor correction IC 29a also has the timer 102. When the timer 102 measures the time period T1, the driver circuit 106 turns on the MOS transistor 30. Thus, even if unexpectedly the power factor correction IC 29a cannot detect that the inductor current IL becomes zero within the predetermined time period T1, the power factor correction IC 29a can cause the AC-DC converter 10 to keep operating continuously without lowering the output voltage Vout.

The present invention has been made in view of the above-described problem in the prior art and has an object to provide an integrated circuit that reduces audible ringing of the coil.

The present invention can provide an integrated circuit that reduces audible ringing of the coil.

Although the present invention is described using the embodiment, the technical scope of the present invention is not limited to the scope of the embodiment described above. As is apparent to those skilled in the art, the embodiment described above can be variously modified or improved. As is apparent from the scope of claims, the technical scope of the present invention may encompass modes and equivalents thereof made by such modification and improvement without departing from the gist thereof.

Note that the order of execution of processes such as operations, procedures, steps, and flows in an apparatus, a system, a program, and a method shown in the scope of claims, the specification, and the drawings may be any order unless there is an explicit statement of a term such as “before” or “prior to” or unless an output from a preceding process is used in a subsequent process. Even if a term such as “first” or “next” is used for convenience in a flowchart in the scope of claims, the specification, or the drawings, it does not mean that the flowchart needs to be executed in that order.

What is claimed is:

1. A switching control circuit for a power supply circuit that generates an output voltage at a target level from an alternating current (AC) voltage, the power supply circuit including
an inductor configured to receive a rectified voltage from a full-wave rectifier circuit configured to rectify the AC voltage,
a transistor configured to control an inductor current flowing through the inductor,
the switching control circuit configured to switch the transistor, the switching control circuit comprising:
a driver circuit configured to
turn on the transistor when the inductor current becomes smaller than a predetermined value, and
turn off the transistor when a time period corresponding to the output voltage elapses;
a detection circuit configured to detect whether an on-period of the transistor is shorter than a first time period; and
a first time measurement circuit configured to measure a second time period upon detecting that the on-period is shorter than the first time period, wherein
upon detecting that the on-period is shorter than the first time period, the driver circuit turns on the transistor based on completion of measurement of the second time period, irrespective of the inductor current, and
the second time period is shorter than a period corresponding to a highest audible frequency.

2. The switching control circuit according to claim 1, comprising a second time measurement circuit configured to measure a third time period when the transistor is turned off,
the third time period being shorter than the second time period, wherein
when the on-period is longer than the first time period, the driver circuit turns on the transistor based on completion of measurement of the third time period.

3. A power supply circuit configured to generate an output voltage at a target level from an alternating current (AC) voltage, the power supply circuit comprising:
an inductor configured to receive a rectified voltage from a full-wave rectifier circuit configured to rectify the AC voltage;
a transistor configured to control an inductor current flowing through the inductor; and
a switching control circuit configured to switch the transistor, the switching control circuit including
a driver circuit configured to
turn on the transistor when the inductor current becomes smaller than a predetermined value and
turn off the transistor when a time period corresponding to the output voltage elapses;
a detection circuit configured to detect whether an on-period of the transistor is shorter than a first time period, and
a first time measurement circuit configured to measure a second time period upon detecting that the on-period is shorter than the first time period, wherein
upon detecting that the on-period is shorter than the first time period, the driver circuit turns on the transistor based on completion of measurement of the second time period, irrespective of the inductor current, and
the second time period is shorter than a period corresponding to a highest audible frequency.
